(19) United States
(12) Patent Application Publication
(10) Pub. No.: US 2009/0192707 A1
(43) Pub. Date: Jul. 30, 2009

(54) Audio Guide Device, Audio Guide Method, And Audio Guide Program

(75) Inventors: Yoshinori Nakatsuka, Tokyo (JP); Yoshihito Ibe, Tokyo (JP); Mitsukatsu Nagashima, Tokyo (JP); Miyuki Ishii, Tokyo (JP)

Correspondence Address: FOLEY AND LARDNER LLP;SUITE 500, 3000 K STREET NW, WASHINGTON, DC, 20007, US

(73) Assignee: PIONEER CORPORATION, Tokyo (JP)

(21) Appl. No.: 11/813,607

(22) PCT Filed: Jan. 11, 2006
(86) PCT No.: PCT/JP2006/300195

§ 371 Date: Jul. 10, 2007

(30) Foreign Application Priority Data
Jan. 13, 2005 (JP) 2005-006853

(51) Int. Cl. G01C 21/26; H04R 25/00; G08B 3/00; G08B 5/00

(52) U.S. Cl. 701/211; 381/370; 340/384.1; 340/815.4

(57) ABSTRACT

A sound guiding apparatus enabling a user to intuitively understand traveling route information from a sound includes a position detecting unit that detects a current position of a user; a determining unit that determines a traveling direction based on the detected current position and a destination of the user; a sound generating unit that generates a sound based on the determined traveling direction; and a sound output unit that outputs the generated sound.

### TECHNICAL FIELD

The present invention relates to a sound guiding apparatus, sound guiding method, and sound guiding program. The application of the present invention is not limited to the above sound guiding apparatus, sound guiding method, and sound guiding program.

### BACKGROUND ART

While navigation systems utilizing GPS have become widespread mainly in vehicles, these systems are increasingly carried and used by individuals in a variety of situations. Although these navigation systems use display screens, a navigation system exists that conveys information of destinations and routes through sound to eliminate the need of watching the display screen for confirmation (see, e.g., Patent Document 1).

Patent Document 1: Japanese Patent Application Laid-Open Publication No. H11-132785

### DISCLOSURE OF INVENTION

### Problems to be Solved by the Invention

However, when listening to destinations and route information with headphones, what is heard is the information itself, such as going to the left or going to the right, for example, and cannot intuitively be understood. In the case of navigation systems using display screens, a user can intuitively understand a traveling course since a current position is shown on a map and an arrow indicates a traveling direction.

On the other hand, since a user must comprehend the sound as a sentence before judging a traveling course when directly listening to the sound through headphones, this is not a mechanism providing intuitive understanding. The information transferred as a sentence is not intuitive and requires time for a user to recognize the information. Therefore, it takes time for a user to make a judgment based on a navigation system. Especially when judging a traffic situation, it is undesirable to take a long time to make a judgment. It is also problematic in that the information has no utility value for people such as foreigners who cannot understand spoken words.

It is an object of the present invention to provide a sound guiding apparatus, sound guiding method, and sound guiding program that can achieve intuitive understanding of course information through sounds to eliminate above problems of conventional technologies.

### Means for Solving Problem

A sound guiding apparatus of an invention according to claim 1, includes a position detecting unit that detects a current position of a user; a determining unit that determines a traveling direction based on the current position detected by the position detecting unit and a destination of the user; a sound generating unit that generates a sound based on the traveling direction determined by the determining unit; and a sound output unit that outputs the sound generated by the sound generating unit.

A sound guiding method of an invention according to claim 6 includes detecting a current position of a user; determining a traveling direction based on the current position detected by the position detecting unit and a destination of the user; generating a sound based on the traveling direction determined by the determining unit; and outputting the sound generated by the sound generating unit.

A sound guiding program of an invention according to claim 7 causes a computer to execute detecting a current position of a user; determining a traveling direction based on the current position detected by the position detecting unit and a destination of the user; generating a sound based on the traveling direction determined by the determining unit; and outputting the sound generated by the sound generating unit.

### BRIEF DESCRIPTION OF DRAWINGS

FIG. 1 is a block diagram of a functional configuration of a sound guiding apparatus according to an embodiment of the present invention;

FIG. 2 is a flowchart of a process of a sound guiding method according to the embodiment of the present invention;

FIG. 3 is an explanatory view of a sound guiding system of the embodiment;

FIG. 4 is a block diagram of a hardware configuration of the sound guiding apparatus;

FIG. 5 is a block diagram of a functional configuration of a sound guiding system; and

FIG. 6 is a flowchart of a process of a sound guiding apparatus.

### EXPLANATIONS OF LETTERS OR NUMERALS

101 position detecting unit

102 determining unit

103 route determining unit

104 sound generating unit

105 sound output unit

106 vibration generating unit

301 sound guiding apparatus

302 headphones

501 GPS

502 direction determining unit

504 sound determining unit

505 motion detecting unit

506 sound image synthesizing unit

511 magnetic sensor

512 headphone unit

513 vibration generating unit

### BEST MODE(S) FOR CARRYING OUT THE INVENTION

A preferred embodiment of a sound guiding apparatus, sound guiding method, and sound guiding program according to the present invention will hereinafter be described in detail with reference to the accompanying drawings.

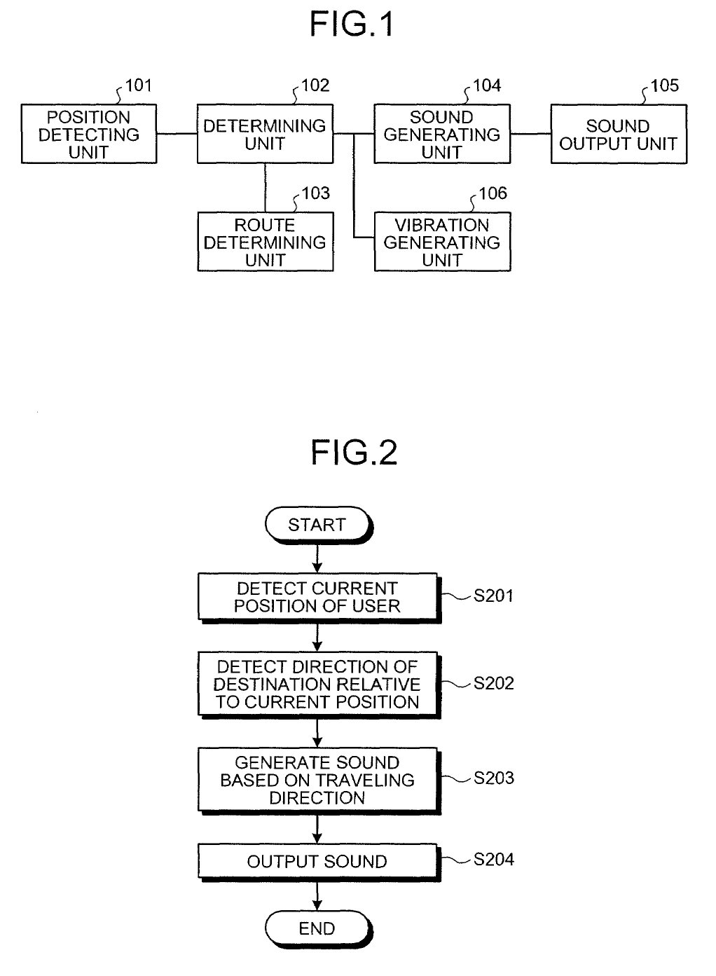

FIG. 1 is a block diagram of a functional configuration of the sound guiding apparatus according to the embodiment of the present invention. The sound guiding apparatus of this embodiment includes a position detecting unit 101, a determining unit 102, a route determining unit 103, a sound generating unit 104, a sound output unit 105, and a vibration generating unit 106.

The position detecting unit 101 detects a current position of a user. The position detecting unit 101 can detect the current position with GPS (Global Positioning System), for example. When using GPS, signals from a plurality of satellites are input to acquire latitudinal and longitudinal information of the user.

The determining unit 102 determines a traveling direction based on the current position detected by the position detecting unit 101 and a destination of the user. The determining unit 102 can preliminarily store, for example, map information, and can store the information of the destination as this map information. The direction of the destination can be determined by comparing the stored information of the destination and the current position. For example, if the destination is west of the current position, it can be determined that the direction of the destination is westward.

The route determining unit 103 obtains a traveling route for a user based on a relationship between the destination and the current position. Although the determining unit 102 determines a traveling direction, the traveling direction may not be westward in some traveling routes even if the destination is west of the current position. For example, a route may go north once, then west, and south. When going north and south, the actual traveling direction is north or south although the destination is westward.

In this case, the direction of the destination is determined by comparing the route information stored in the map information and the current position. Therefore, the traveling direction can be north when the user goes north along the route, and the traveling direction can be south when the user goes south. The determination result is delivered to the determining unit 102 and the determining unit 102 determines a traveling direction based on the route obtained by the route determining unit 103 and the current position of the user.

The sound generating unit 104 generates a sound based on the traveling direction determined by the determining unit 102. For example, a sound can be generated such that the sound is heard from a left headphone when the traveling direction is leftward and from a right headphone when the traveling direction is rightward. With regard to the sound, voices for “forward”, “back”, “left”, and “right” corresponding to directions can preliminarily be stored, and the sound to be output can be generated by retrieving the stored voices. The sound can be a sound other than a voice, such as a beeping sound.

Alternatively, the head-related transfer function can be used to manipulate the arrival time of the sound at the ears such that the sound is heard from the front, back, left, or right even when the sound is heard with headphones. The retrieved sound can be combined with the head-related transfer function to generate a sound such that the sound is heard from the traveling direction. The output direction of the sound can be “top” and “bottom” as well as “forward”, “back”, “left”, and “right”. For example, if an ascending slope is located diagonally forward right, the direction can be somewhat upward in the diagonally forward right direction.

The sound output unit 105 outputs from headphones the sound generated by the sound generating unit 104, for example. The vibration generating unit 106 generates vibration based on the traveling direction determined by the determining unit 102.

FIG. 2 is a flowchart of a process of a sound guiding method according to the embodiment of the present invention. First, the position detecting unit 101 detects a current position of a user (step S201). The determining unit 102 determines a direction of the destination relative to the current position based on the current position detected by the position detecting unit 101 and the destination of the user (step S202). After the route determining unit 103 obtains a traveling route of the user based on a relationship between the destination and the current position, the determining unit 102 can also obtain a traveling direction based on the obtained traveling route and the current position of the user.

The sound generating unit 104 generates a sound based on the traveling direction (step S203). With regard to the sound, voices for “forward”, “back”, “left”, and “right” corresponding to directions can preliminarily be stored, and the sound to be output can be generated by retrieving the stored voices. The sound can be a sound other than voices, such as a beeping sound. The retrieved sound can be combined with the head-related transfer function to generate a sound such that the sound is heard from the traveling direction. The output direction of the sound can be “top” and “bottom” as well as “forward”, “back”, “left”, and “right”. For example, if an ascending slope is located diagonally forward right, the direction can be somewhat upward in the diagonally forward right direction.

The sound output unit 105 outputs the generated sound (step S204). The vibration generating unit 106 can generate vibration based on the traveling direction determined by the determining unit 102. After the vibration is generated, the sound can also be output. In this case, since a user can wait for the next output sound when the vibration is generated, the user can concentrate on recognizing the sound. A series of process is then terminated.

### EXAMPLES

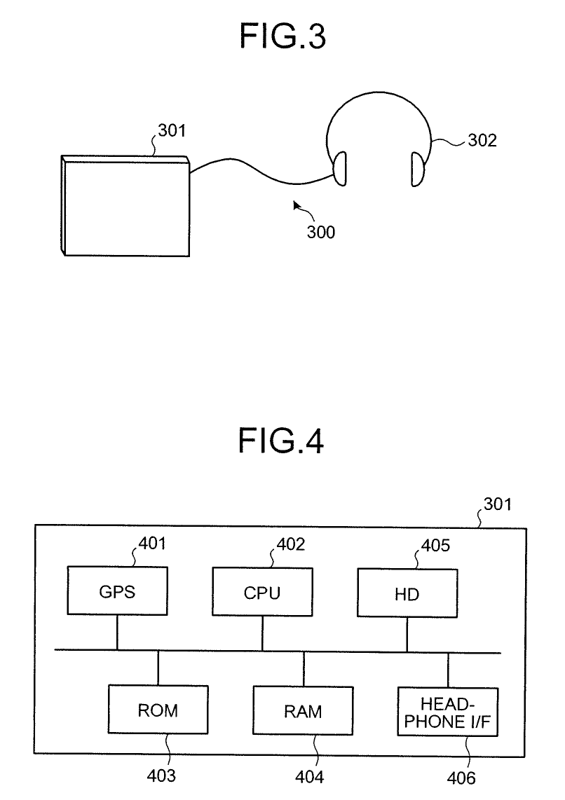

FIG. 3 is an explanatory view of a sound guiding system of the embodiment. A sound guiding system 300 is configured by a sound guiding apparatus 301 and headphones 302. A user carries the sound guiding apparatus 301 having such a size that can be carried and puts the headphones 302 on the head to use the sound guiding system 300. Although the headphones 302 are used in the description of FIG. 3, an apparatus such as speakers capable of transmitting a sound to a user may be used instead of the headphones 302. Although the headphones 302 are put on the head when using the headphones 302, the speakers can be mounted on positions other than the head. However, the speakers are mounted on the right and left sides of the body to provide directionality of the sound. Vibration apparatuses can also be mounted along with the speakers. In this case, the Vibration apparatuses are also mounted on the right and left sides of the body to provide directionality of the vibration.

### (Hardware Configuration of Sound Guiding Apparatus)

FIG. 4 is a block diagram of a hardware configuration of the sound guiding apparatus. The sound guiding apparatus 301 includes a GPS 401, a CPU 402, a ROM 403, a RAM 404, a HD 405, and a headphone I/F 406.

The GPS 401 inputs signals from a plurality of satellites to obtain and output a latitude and a longitude. The CPU 402 generally controls the sound guiding apparatus 301 of this example. The ROM 403 stores programs such as a boot program. The RAM 404 is used as a work area of the CPU 402. The HD 405 is a nonvolatile readable/writable magnetic memory. The headphone I/F 406 is an interface that receives the sound output from the CPU 402 to transmit the sound to the headphones 302.

FIG. 5 is a block diagram of a functional configuration of the sound guiding system. As shown in FIG. 3, the sound guiding system 300 is configured by the sound guiding apparatus 301 and the headphones 302. The sound guiding apparatus 301 is configured by a GPS 501, a direction determining unit 502, route information 503, a sound determining unit 504, a motion detecting unit 505, and a sound image synthesizing unit 506. The headphones 302 are configured by a magnetic sensor 511, a headphone unit 512, and a vibration generating unit 513.

The GPS 501 inputs signals from a plurality of satellites to obtain a latitude and a longitude. The GPS 501 has map data and identifies a current position and a traveling route from the input latitude and longitude.

The direction determining unit 502 obtains a traveling direction from the current position, the destination, and the traveling route. When moving linearly from the current position toward the destination, the traveling direction is a direction toward the destination. However, an actual traveling route may not linearly lead to the destination and may make a detour. In this case, the traveling direction is a direction toward a subsequent point on the traveling route. Therefore, the direction determining unit 502 acquires the route information 503 based on the current position and the destination. The traveling direction is then obtained from the current position and this route information 503. The traveling route may go straight along a direct road or may turn, for example, right at a crossroad or a three-way intersection. In this case, the traveling direction is a direction corresponding to the right.

The sound determining unit 504 retrieves a sound corresponding to the traveling direction obtained by the direction determining unit 502 and the current direction. The sound may be a voice. Indication by the voice in this case can be different voices depending on the situation, for example, a name of the current position. Alternatively, the voice can indicate the next direction to take, such as “forward”, “back”, “left”, and “right”. When making a turn along the traveling route, the voice can indicate a turning direction at the time of the turn. In another case, the sound can be various sounds, such as a beeping sound, capable of telling the user a direction. The motion detecting unit 505 detects motion of the head of the user, which is detected by the headphones 302.

The sound image synthesizing unit 506 converts the sound output from the sound determining unit 504 into a sound reproduced by the headphones 302. That is, the head-related transfer function is combined with the sound output from the sound determining unit 504 such that the generated sound data are output from a specified direction. A sound direction sensed by the user can be manipulated by combining the head-related transfer function with the sound. The output direction of the sound can be “top” and “bottom” as well as “forward”, “back”, “left”, and “right”. For example, if an ascending slope is located diagonally forward right, the direction can be somewhat upward in the diagonally forward right direction.

The head-related transfer function will be described. The head-related transfer function can be combined with a sound to create an environment where the sound is virtually heard from a certain direction when listening with headphones. In the human auditory perception, a sound arriving first at the ears is used to perceive a sound direction and to recognize a “sound image” such as an image, conceptualization, of the direction from which the sound is coming and the volume of the sound.

That is, a human being has the sound image localization ability that can acquire not only loudness, pitch, and tone of a sound but also spatial information thereof such as direction and distance when hearing the sound. The sound direction can virtually be determined by clarifying and controlling physical factors of the sound image localization. The clues of the sound image localization includes the time difference and intensity difference between signals arriving at both ears, changes in acoustic wave frequency characteristics generated by diffractions due to the head and ear lobes, and reflection by room walls, etc.

These effects are reflected in the head-related transfer function. The head-related transfer function is sound transfer characteristics from a sound source to the eardrums of a listener, including the head and ear lobes, in a space (free space) having no reflected wave. On the other hand, the room transfer function represents transfer characteristics from a sound source to a listener in a room and includes effects of reflection by room walls, etc. Various sound environments can be imitated by combining these two transfer functions.

When hearing a sound with the headphones 302, the sound image is moved in accordance with the motion of the head. Therefore, the magnetic sensor 511 captures the motion of the head for more realistic imitation of the sound image. The sound image synthesizing unit 506 combines the head-related transfer function changing in accordance with the head motion captured by the magnetic sensor 511 with the original sound signal to perform control such that the sound image is always located at the same position.

The magnetic sensor 511 is a sensor that magnetically detects the motion of the head. The detected motion of the head is sent to the motion detecting unit 505. The headphone unit 512 is speakers that can apply the output of the sound image synthesizing unit 506 as sounds to the left and right ears of the user.

The vibration generating unit 513 vibrates the headphone unit 512 in accordance with the traveling direction output from the direction determining unit 502. For example, when the traveling direction is leftward, the vibration generating unit 513 vibrates the headphone unit 512 in a portion applied to the left ear. Conversely, for example, when the traveling direction is rightward, the vibration generating unit 513 vibrates the headphone unit 512 in a portion applied to the right ear. Since the vibration is generated, a user can directly sense the traveling direction not only with auditory perception but also with the body, and the traveling direction can certainly be delivered to a user even when the traveling direction may not be delivered to a user only with a sound, for example, when a user is sleepy.

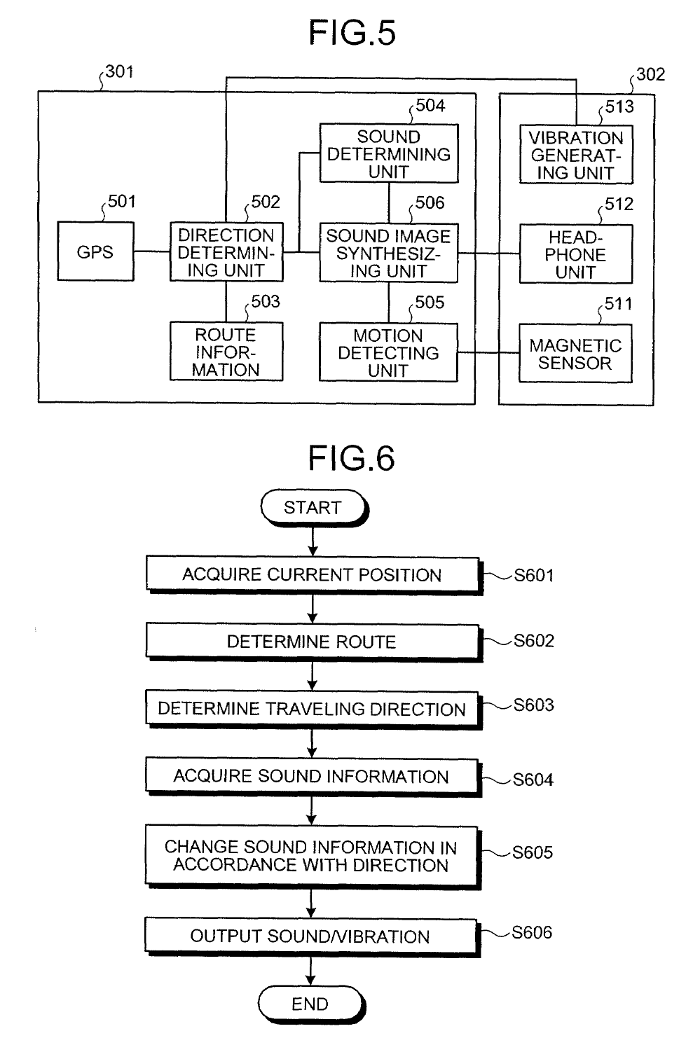

FIG. 6 is a flowchart of a process of the sound guiding apparatus. First, the GPS 501 acquires a current position (step S601). That is, the GPS 501 identifies the current position from the latitude and longitude based on signals from satellites.

The direction determining unit 502 refers to the route information 503 from the acquired current position to determine a traveling route (step S602). The direction determining unit 502 compares the traveling route and the current position to determine a traveling direction (step S603).

The sound determining unit 504 acquires sound information (step S604). That is, when the traveling direction is changed, a sound for a changed traveling direction is determined as an output sound. Alternatively, information of the current position acquired by the GPS 501 is output as the output sound at regular time intervals to notify a user of the current position.

The sound image synthesizing unit 506 changes the sound information acquired from the sound determining unit 504 in accordance with direction (step S605). That is, the above-mentioned head-related transfer function is combined with the sound output from the sound determining unit 504. The sound image synthesizing unit 506 combines the head-related transfer function changing in accordance with the head motion captured by the magnetic sensor 511 with the original sound signal to perform control such that the sound image is always located at the same position.

The sound/vibration is then output (step S606). That is, the sound image synthesizing unit 506 outputs the synthesized sound information from the headphone unit 512. Meanwhile, the direction determining unit 502 outputs the information of the direction to the vibration generating unit 513, and the vibration generating unit 513 drives the headphone unit 512 to vibrate the portion corresponding to the traveling direction. A series of process is then terminated.

The sound and the vibration can be generated at the same time. Alternatively, the vibration can be generated before the sound is generated. For example, when a user makes a turn from the traveling direction, the vibration can be provided immediately before the turning point and the sound can then be output. Since the vibration is generated first, the user can concentrate on recognizing the next output sound. The vibration of this case may be stopped before generating the sound or may be continued after the sound is generated. Alternatively, the sound can be generated before the vibration is generated.

As described above, according to the sound guiding apparatus, the sound guiding method, and the sound guiding program, the sound output and vibration of headphones can be controlled in accordance with the traveling directions and, therefore, the user can intuitively comprehend the current position and the traveling directions.

The sound guiding method described in the embodiment can be realized by executing a preliminarily prepared program with a computer such as PDA. The program is recorded on a computer-readable recording medium such as hard disks, flexible disks, CD-ROM, MO, and DVD and is read from the recording medium and executed by the computer. The program may be a transmission medium that can be distributed through a network such as the internet.

1-7. (canceled)

8. A sound guiding apparatus comprising:
a position detecting unit that detects a current position of a user;
a determining unit that determines a traveling direction based on the current position and a destination of the user;
a sound generating unit that generates a sound based on the traveling direction; and
a sound output unit that outputs the sound.

9. The sound guiding apparatus according to claim 8, further comprising:
a route determining unit that determines a traveling route for the user based on a relationship between the current position and the destination,
wherein the determining unit determines the traveling direction based on the traveling route and the current position.

10. The sound guiding apparatus according to claim 8, wherein the sound generating unit generates the sound such that a direction of a sound image is indicative of a direction of the destination relative to the user.

11. The sound guiding apparatus according to claim 8, wherein
the sound guiding apparatus is connected to a headphone unit having speakers that are opposed on a right side and a left side of the user,
the sound output unit outputs the sound via the headphone unit, and
the sound generating unit generates, corresponding to a direction of the destination relative to the user, the sound output via the speaker on the left side and the sound output via the speaker on the right side to have a different volume.

12. The sound guiding apparatus according to claim 11, wherein
the sound generating unit generates the sound output via the speaker that corresponds to the direction of the destination to be louder than the sound output via the speaker that does not correspond to the direction of the destination.

13. The sound guiding apparatus according to claim 8, further comprising:
a vibration generating unit that generates vibration based on the traveling direction.

14. A sound guiding method comprising:
detecting a current position of a user;
determining a traveling direction based on the current position and a destination of the user;
generating a sound based on the traveling direction; and
outputting the sound.

15. The sound guiding method according to claim 14, further comprising:
determining a traveling route for the user based on a relationship between the current position and the destination,
wherein the determining includes determining the traveling direction based on the traveling route and the current position.

16. The sound guiding method according to claim 14, wherein the generating includes generating the sound such that a direction of a sound image is indicative of a direction of the destination relative to the user.

17. The sound guiding method according to claim 14, wherein
the outputting includes outputting the sound via a headphone unit having speakers that are opposed on a right side and a left side of the user, and
the generating includes generating, corresponding to a direction of the destination relative to the user, the sound output via the speaker on the left side and the sound output via the speaker on the right side to have a different volume.

18. The sound guiding method according to claim 17, wherein
the generating further includes generating the sound output via the speaker that corresponds to the direction of the destination to be louder than the sound output via the speaker that does not correspond to the direction of the destination.

19. The sound guiding method according to claim 14, further comprising:
generating a vibration based on the traveling direction.

20. A computer-readable recording medium storing therein a computer program that causes a computer to execute:
detecting a current position of a user;
determining a traveling direction based on the current position and a destination of the user;
generating a sound based on the traveling direction; and
outputting the sound.

21. The computer-readable recording medium according to claim 20, wherein the computer program further causes the computer to execute:
determining a traveling route for the user based on a relationship between the current position and the destination,
wherein the determining includes determining the traveling direction based on the traveling route and the current position.

22. The computer-readable recording medium according to claim 20, wherein
the generating includes generating the sound such that a direction of a sound image is indicative of a direction of the destination relative to the user.

23. The computer-readable recording medium according to claim 20, wherein
the outputting includes outputting the sound via a headphone unit having speakers that are opposed on a right side and a left side of the user, and
the generating includes generating, corresponding to a direction of the destination relative to the user, the sound output via the speaker on the left side and the sound output via the speaker on the right side to have a different volume.

24. The computer-readable recording medium according to claim 23, wherein
the generating further includes generating the sound output via the speaker that corresponds to the direction of the destination to be louder than the sound output via the speaker that does not correspond to the direction of the destination.

25. The computer-readable recording medium according to claim 20, wherein the computer program further causes the computer to execute:
generating a vibration based on the traveling direction.
